(19) United States
(12) Patent Application Publication
(10) Pub. No.: US 2003/0020440 A1
(43) Pub. Date: Jan. 30, 2003

(54) Power supply circuit

(76) Inventor: Pieter Martin Risseeuw, Brugge (BE)

Correspondence Address: Michael E. Marion, c/o U.S. PHILIPS CORPORATION, Intellectual Property Department, 580 White Plains Road, Tarrytown, NY, 10591, US

(21) Appl. No.: 10/188,140

(22) Filed: Jul. 2, 2002

(30) Foreign Application Priority Data
Jul. 9, 2001 (EP) 01202828.8

(51) Int. Cl. G05F 1/40

(52) U.S. Cl. 323/282

(57) ABSTRACT

A power circuit comprises a power supply (1) operable in a burst mode having on and off alternating phases and a continuous mode, a switch (4), a phase detector (5) for detecting the burst mode phase of the power supply (1) and for generating a signal indicative of the phase of the power supply (1), and a switch disabler (6) dependent on the signal from the phase detector (5) for disabling the switch (4) depending on the phases of the burst mode.

The burst mode phase may be detected using a capacitor (C1) and resistor (R4) connected across an output of the power supply (1) with a time constant smaller than the burst mode period.

This circuit allows switching on of a high load (R3) in synchronization with an on phase of the burst mode, reducing voltage dips and preventing unwanted re-setting of a microprocessor present in the circuit.

The present invention relates to a power circuit. The invention also relates to a display apparatus.

The invention is applicable to power circuits comprising power supplies for display apparatus, including Visual Display Units (VDU).

The invention is particularly related to a circuit for a power supply which can operate with high and low loads and switch mode to adjust to the load connected to it.

A switched-mode power supply operates under low load in a so-called burst mode in which power is supplied in bursts at low frequency via a capacitor. This mode is commonly used to save power in modem electrical apparatus, while providing sufficient power to keep the circuit essentially active, eg to power a microprocessor and possibly optical indicators. When the microprocessor connects a device with a large load, such as a VDU display, then the switched-mode power supply switches into a continuous mode, supplying a steady continuous current to power the device.

However, at the time that the switching takes place, if the supply is in an off phase of the burst, then there is a time delay in the feedback and the output voltage will tend to dip, often causing undesirable resetting of the microprocessor.

It is an object of the present invention to provide a power supply circuit which reduces dips on its output voltage. The invention is defined by the independent claims. The dependent claims define advantageous embodiments.

Preferably the action is to switch the power supply from burst mode into continuous mode, but other actions such as generating reset pulses are also possible.

Hence a circuit can be constructed according to the invention to detect when the supply is in an on phase and synchronise the switching from the burst mode to the continuous mode with an “on” phase of the burst, or alternatively synchronise the switch with the “off” phase of the burst depending upon the application. Equally an action can be avoided by blocking, disabling or stopping the action during any one of the two phases depending upon the application.

The burst mode phase detector may comprise a capacitor C connected across a load R. The values of these components are preferably chosen to ensure that the capacitor discharge is fast, particularly that the capacitor discharge time is less than the burst period of the power supply, i.e. the time constant of the RC circuit is smaller than the burst period.

These and other aspects of the invention will be apparent from and elucidated with reference to the drawings, in which:

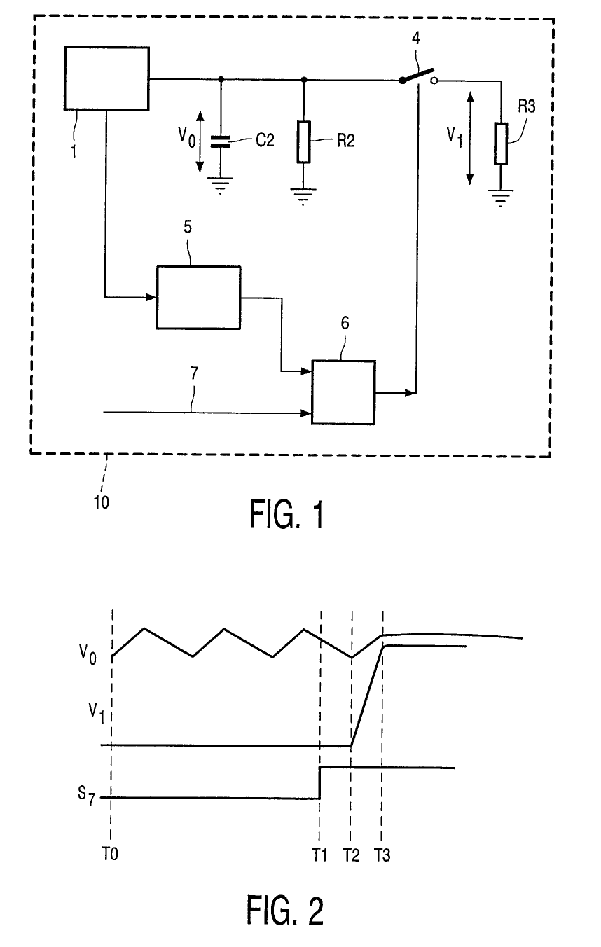

FIG. 1 is a block diagram of a circuit according to the present invention;

FIG. 2 is a timing diagram relating to the circuit of FIG. 1; and

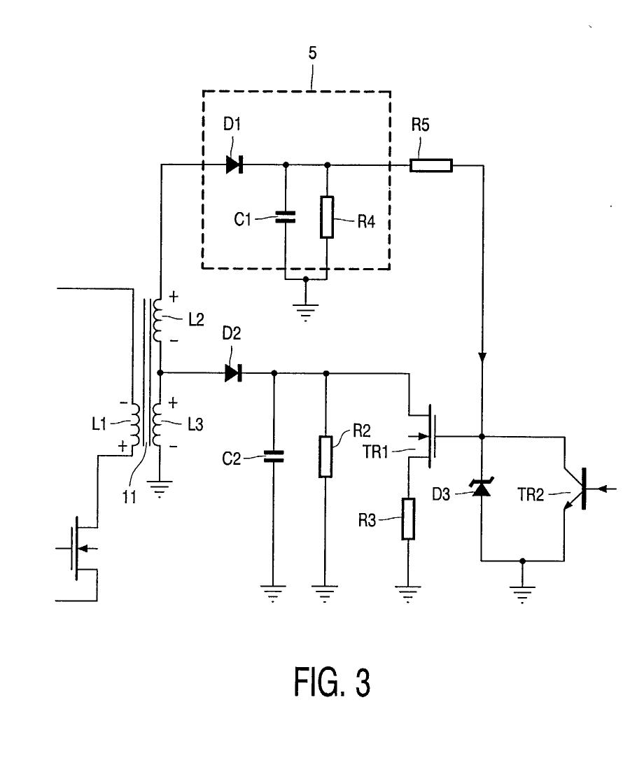

FIG. 3 is a more detailed circuit diagram of the circuit of FIG. 1.

In FIG. 1 a power supply 1 has an output Vo present across a low load R2 and supplied to a switch 4 connected to a high load R3. The high load voltage V1 is the voltage across the high load R3. A capacitor C2, which is typically an electrolitic capacitor is connected across the load R2. A burst phase detector 5 has its input connected to the supply 1 and its output, via an AND gate 6, to the switch 4. A second input of the AND gate 6 is connected to a switch control line 7 for example from a microprocessor (not shown). The AND gate 6 performs the function of a switch disabler, which controls when switch 4 is disabled or enabled.

While the low load R2 only is connected, the power supply operates in burst mode supplying power in low frequency bursts to keep energy supply low.

If the circumstances are such that the high load R3 needs to receive power, then a switch control signal S7 is supplied on the switch control line 7 to one input of the AND gate 6. If the power supply 1 is in an “off” phase of the burst mode at that moment then the burst detect circuit 5 will provide a low output at the second input of the AND gate 6 and the output of the gate 6 will be low, leaving the switch 4 off and the high load R3 will remain unconnected to the power supply 1. However, if the burst phase detector 5 determines that the power supply 1 is in an “on” phase of the burst mode, then it will supply a positive output to the second input of the AND gate 6, the output of which will go high causing the switch 4 to be activated and connect the power supply 1 to the high load R3. When the high load R3 is connected, the power supply switches to the continuous mode in a manner known to persons skilled in the art.

The circuit thus ensures that the high load R3 is only connected to the power supply 1 at a time which corresponds to an “on” phase of the burst from the power supply 1. This reduces dips in the power supply 1 output voltage Vo which result from the power supply 1 trying to switch from burst mode to continuous mode while it is in an “off” phase of the burst cycle.

The load R3 may comprise one or more circuits of a display apparatus. The switched mode power supply and the load may both be part of a display apparatus 10.

FIG. 2 is a timing diagram illustrating the operation of the circuit of FIG. 1. In the time period T0-T1 the switch control signal S7 is off and a low signal is supplied on line 7 as indicated in the diagram. The power supply 1 operates in burst mode during the period T0-T2 as is indicated by the cycling of the output voltage Vo. The rising edges of the Vo signal represent “on” phases of the bursts, ie time periods during which the supply is providing power and the capacitor is being charged, whereas the falling edges represent the “off” phases of the bursts, ie the time periods during which the supply is “off” and the capacitor is being discharged.

At time T1, the switch control signal S7 is turned on as indicated by the rising edge of the signal S7 of FIG. 2. At this time the supply 1 is in an “off” phase of the burst, as can be seen by the falling edge of the signal Vo. The AND gate 6 therefore retains a low output and the switch 4 is not activated so that the high load R3 is not yet connected to the supply 1, as indicated by the high load voltage V1 staying at zero.

At time T2 the power supply switches into an “on” phase again and Vo changes to a rising edge causing the AND gate 6 to provide a high output and activate switch 4 to connect the high load R3. It can thus be seen in FIG. 2 that the high load voltage V1 rises until time T3 when it reaches a constant value and the power supply has been switched into continuous mode.

In FIG. 3 a more detailed circuit diagram is shown depicting a particular embodiment of the present invention.

The power supply comprises a transformer 11 with a primary winding L1, a first secondary winding L2 and a second secondary winding L3. The second secondary winding L3 is coupled via a diode D2 to the circuit loads, in particular capacitor C2, a low load R2, and a high load R3 via a switch formed by a transistor TR1 in the form of a field effect transistor (FET). The burst phase detector 5 of FIG. 1 is formed, in this embodiment, by a rectifier diode D1 connected in series with a parallel circuit of a small capacitor C1 and a small resistor R4. One terminal of the diode D1 is connected to a terminal of the first secondary winding L2. The gate of the transistor TR 1 is connected via a resistor R5 to the detector 5. The zener diode D3 limits the gate voltage of the transistor TR 1.

When the power supply is in an “on” phase of the burst mode, the capacitor C1 is being charged, or charged. When the supply is in an “off” phase the capacitor C1 is discharged via small resistor R4. The discharge is arranged to be quite fast by choosing the time constant, being the product of the value of capacitor C4 and resistor R4, sufficiently short. Thus, when the supply is in an “off” phase of the burst mode, the capacitor C1 is discharged resulting in a voltage on the gate of transistor TR1 too low to turn on transistor TR1. If transistor TR2 is off, ie if there is a low signal at its base, then transistor TR2 will block. While transistor TR2 is blocked and the power supply is in an “on” phase of the burst mode, the voltage across capacitor C1 will result in a current flowing via resistor R5 to the gate of transistor TR1. This current will switch on the FET transistor TR1, thus switching the high load R3 into the circuit to receive power from the second secondary winding L3 of the transformer 11. Due to the additional load formed by the high load R3 the power supply switches into continuous mode immediately.

The signal on the base of transistor TR2 can be a “standby” signal indicative of whether the high load R3 is to be switched in. This “standby” signal may be derived from a microprocessor in the circuit or by some other suitable means. In certain circumstances it may be manually generated.

As soon as the “standby” signal goes high the transistor TR2 switches on blocking the transistor TR1, by means of sinking the gate drive, preventing the high load R3 from being connected to the power supply.

Thus the circuit of FIG. 3 achieves the result that the high load R3 is only switched into the circuit while the power supply is in an “on” phase of the burst mode. Hence unwanted power dips are reduced or avoided and there is less risk of a microprocessor in the circuit being undesirably reset as a result of such dips.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A power circuit comprising:
a power supply, operable in two mutually exclusive different modes, viz. a burst mode having a first and a second alternating phase and a continuous mode;
a switch for initiating an action;
a phase detector for detecting the phase of the burst mode to generate a signal indicative of the phase of the burst mode; and
a switch disabler dependent on the signal from the phase detector for disabling the switch if the burst mode is in the first phase to prevent the action during the first phase and to enable the action during the second phase.

2. A power circuit according to claim 1, wherein a load is present and the action is that of coupling the power supply to the load.

3. A power circuit according to claim 2, wherein an input of the switch disabler is coupled to a switch control line for receiving an other signal indicating whether to initiate the action.

4. A power circuit according to claim 1, wherein the phase detector comprises a capacitor and a resistor connected in parallel and having capacitance, respectively resistance values such that the discharge time of the capacitor is less than a burst mode period of the power supply.

5. A power circuit according to claim 4, wherein the parallel connection of the resistor and capacitor are coupled to an output of the power supply via a diode.

6. A power circuit according to claim 1 wherein the switch comprises a field effect transistor with its gate connected to the output of the switch disabler.

7. A display apparatus comprising the power circuit of claim 1.
